(19) United States
(12) Patent Application Publication
(10) Pub. No.: US 2025/0238647 A1
(43) Pub. Date: Jul. 24, 2025

(54) METHOD FOR SELECTING FIDUCIAL MARKERS FOR A PRINT MEDIA AND A PRINTER

(71) Applicant: Canon Production Printing Holding B.V., Venlo (NL)

(72) Inventors: Tim R. FRIJNTS, Venlo (NL); Johannes B.M. SEVENICH, Venlo (NL)

(73) Assignee: Canon Production Printing Holding B.V., Venlo (NL)

(21) Appl. No.: 19/016,513

(22) Filed: Jan. 10, 2025

(30) Foreign Application Priority Data
Jan. 18, 2024 (EP) 24152639.1

(51) Int. Cl. G06K 15/02; B41J 3/28; B41J 3/44; B41J 29/00; H04N 1/047

(52) U.S. Cl. CPC G06K 15/027; B41J 3/28; B41J 3/44; B41J 29/00; G06K 15/1878; G06K 15/1888; H04N 1/0473; G06K 2215/0094

(57) ABSTRACT

A method for determining fiducial markers to be printed on a substrate by means of a printer which is configured to execute a print process and to transport the substrate relatively to a gantry comprising a print head and an image scanner in a main scanning direction over a print surface underneath the gantry. The print head and the image scanner are moveable along the gantry in a sub-scanning direction perpendicular to the main scanning direction. The printhead is configured to eject marking material on the substrate and the image scanner is configured to create scanned images of the printed substrate. Based on properties of the scanned images of prepared patches on the substrate a color and a shape of the fiducial markers to be printed is selected and stored per type of substrate.

### BACKGROUND OF THE INVENTION

### 1. Field of the Invention

The present invention relates to a method for determining fiducial markers to be printed on a substrate by means of a printer which is configured to execute a print process and to transport the substrate relatively to a gantry comprising a print head and an image scanner in a main scanning direction over a print surface underneath the gantry, the print head and the image scanner moveable along the gantry in a sub-scanning direction perpendicular to the main scanning direction, the printhead configured to eject marking material on the substrate and the image scanner configured to create scanned images of the printed substrate, and the printer comprising a print controller for control of the print process and comprising a storage with print settings, the method comprising the steps of transporting the substrate over the print surface underneath the gantry, the image scanner moving along the gantry in at least one swath, the image scanner creating at least one digital image of the substrate when the image scanner is moving along the gantry in the sub-scanning direction, and the image scanner sending the at least one created digital image to the print controller.

The image scanner may also be called “scanner” hereinafter.

A fiducial marker may also be called “marker” hereinafter.

The substrate may also be called “media” or “print media” hereinafter.

### 2. Description of Background Art

In a roll to roll printer in which a paper step during printing is corrected using printed fiducial markers next to the image, a scanner device attached at the printhead carriage may be used to detect the printed markers. The fiducial markers are objects placed in the field of view of an image scanner which appear in the image produced, for use as a point of reference or a measure. The markers have different colors and shapes depending on the media characteristics. Somewhat textured media should use enhanced markers, while heavily textured and patterned media need to use robust markers. Media which are not white and opaque (colored, transparent, mirror like) often need to use white ink markers. Especially for colored media it can be difficult to determine the correct marker color without trial and error. As the scanner uses blue light, which is absorbed by the yellow media and not by the blue media, yellow media looks dark in the scan made by the scanner, requiring white markers and blue media looks light, requiring CMYK markers. CMYK stands for Cyan, Magenta, Yellow and Black, while W stands for White. But a lot depends on how yellow or blue the media are. In case of poor contrast (colored media) it may be needed to use robust markers despite a lack of texture. For each new medium a so-called medium calibration should be done to calibrate the media step for the first meter and step size dependent error. For both the calibration and the subsequent prints with markers in the margin, an error is given if too many markers cannot be identified successfully. However, selection of a more robust marker type comes at the cost of increased marker width, i.e. less space for the customer print.

Until now the above-mentioned problem was solved by using a manual. For some media the user is guided to the correct setting. But for some media it still fails. A specific gloss, color, surface structure, metal, transparency, etc, cannot be described in all detail. Probably measuring devices would be needed to do this correctly. So in practice good settings are found by experience or by iteration.

### SUMMARY OF THE INVENTION

It is an object of the invention to provide a method which mitigates the here-above mentioned problem.

In accordance with the present invention, a method for printing according to claim 1 is provided.

According to an embodiment the step of selecting the at least one ink color comprises the sub-steps of retrieving from the storage a plurality of contrast thresholds for measured contrast levels, determining a mean contrast level from the at least one determined contrast level determined, determining if the mean contrast level is low or high compared to a first contrast threshold of the plurality of contrast thresholds, in case of a high mean contrast level, selecting a color of the marking material from a CMYK spectrum, in case of low mean contrast level
in case of a mean contrast level higher than a second contrast threshold of the plurality of contrast thresholds which is lower than the first contrast threshold, selecting both white and a color of the marking material from the CMYK spectrum, and
in case of a mean contrast level which is lower than the second contrast threshold, selecting a color white for the marking material.

According to the present invention the selection of a marker type (color and shape) is done automatically as a first step of a media calibration. In the invented method the print media is scanned and by means of the scanner response it is determined how light or dark the print media is and how much structure it has. The light of an illumination which arrives for each scan line at a sensor is integrated for a certain amount of time. The scanner response may be a number of bits, where with a predetermined illumination and integration time the scanner response values may vary from a low number which may correspond to a perfectly dark image to a high number which may correspond to a perfectly white image. After a subsequent brightness calibration of the scanner—with or without light on a white medium—the scanner response values are set to a value between 0 and 255 on an 8 bit scale, i.e. the scanned image is converted to an 8 bit value which defines the final scanner response.

In many cases the selection of colors and shapes of the fiducial markers is enough to determine a preferred marker type or at least to narrow down the options.

A high contrast may be determined in case of a light, colored or white substrate. A low contrast may be determined in case of a dark, colored, transparent and/or mirror-like substrate. In case of high contrast CMYK marker should be used, for middle contrast both white and CMYK markers may be tried out in a following step. In case of a low contrast white markers should be used.

The contrast determination may be done anytime a media is used for the first time to check if user choices make sense. If the user choices do not make sense when compared to the contrast determination results, the user is advised to not start printing.

The is advised how the change the marker setting, to perform an additional marker selection test or the marker settings may be changed automatically without user intervention.

According to an embodiment the method comprises the step of printing different markers types and color and evaluating a visibility of the different marker types. A marker type is determined by its color and its shape. Firstly a marker color is determined. If the determined colors fails the visibility test, the determined colors are tried out with more robust markers. For example, after determining the color, the trying out starts with the smallest marker until a marker with sufficiently high success rate is determined (e.g. >95%). The choice of marker width must be communicated back to the raster image processing (RIP) software in order to set the correct printable media width. It may be necessary for the user to enter this value into the RIP software, but preferably it is communicated automatically. For example, the marker shape and color can be selected automatically, by adding a default “automatic” option to the marker type selection. If the automatic option is selected, a “use white markers” option is greyed out. In the very rare case no usable marker can be found additional options may be considered, e.g. a further increase of the marker width, acceptance of a higher failure rate (better lower accuracy than no measurement), etc.

According to the present invention the marker selection calibration can also be done automatically or semi-automatically in case of a print error generated by the print controller of the printer, e.g. an error like “cannot read markers for media step control”, The inventors have recognized that selection of the wrong marker type is a possible reason for marker failures besides other reasons which should also be evaluated automatically where possible such as scanner contamination or too many failing nozzles. During the marker selection it may be evaluated which failing nozzles are used in the markers and a uniformity of the scanned media may be evaluated at different width positions of the media.

By applying the method according to the present invention a reduction of the number of errors during calibration and printing is realized. Also a complexity for critical media is reduced (e.g. dark colored media, semi-transparent print media). The method gives a higher flexibility: state of art is that markers can have the colors Yellow, Black and White, but according to the present method in principle all colors CMYKW could be used. The marker width could also be increased even further if needed which may be implemented as a parameter in the calibration software of the print controller. The present method provides an automatic diagnosis for one of the most prevalent errors in the field.

According to an embodiment the step of selecting the at least one shape comprises the sub-steps of retrieving from the storage a plurality of standard deviation thresholds for standard deviation levels, determining a mean or median standard deviation from the plurality of determined standard deviations, determining if the determined mean of median standard deviation is respectively low, high or very high compared to the plurality of thresholds for standard deviations, and based on the determined mean or median standard deviation, select at least one size for the at least one shape.

According to the present invention a standard deviation of the scanner response in a patch is determined to evaluate a roughness or pattern of the print medium. However, other measures to evaluate the roughness or pattern may be envisioned.

A low standard deviation is an indication for a smooth media, where markers of a standard shape and size can be used. A high standard deviation is an indication for a rougher print medium or a print medium with a pattern, where both the standard shape and a more enhanced or robust shape can be used for trying out the best selection of the fiducial markers. The more enhanced or robust shape has a larger size than the standard shape. A very high standard deviation is an indication for a very rough print medium, i.e. an elevated print medium or a print medium with an elevated pattern. In case of a very high standard deviation, the enhanced and robust markers should be selected for further trying out the best selection of the fiducial markers.

By doing so, it is determined which fiducial marker is needed based on the media properties in order to prevent errors due to too many unreadably markers, while also the marker is kept as small as possible.

According to an embodiment the first patch comprises an edge of the substrate, and the method comprises the step of determining the at least one contrast level between the substrate and the print surface by means of the first patch. Especially when the print surface is black a substantial contrast between print media and the (black) print surface at the media edge can detected.

According to an embodiment the method comprises the step of receiving a print job to be printed on the substrate and printing the print job together with fiducial markers on the substrate, the fiducial markers having the at least one selected color and the at least one selected shape on the substrate.

The present invention also relates to a printer configured to execute a print process and to transport a substrate relatively to a gantry comprising a print head and an image scanner in a main scanning direction over a print surface underneath the gantry, the print head and the image scanner moveable along the gantry in a sub-scanning direction perpendicular to the main scanning direction, the printhead configured to eject marking material on the substrate and the image scanner configured to create scanned images of the printed substrate, and the printer comprising a print controller for control of the print process and comprising a storage with print settings, wherein the print controller is configured to execute the steps of the method according to the present invention.

According to an embodiment the printer is a roll-fed printer or a sheet-fed flatbed printer.

The present invention also relates to a software product comprising program code on a machine-readable medium, which program code, when loaded into a print controller of a digital printer, causes the print controller to execute the steps of a method according to the present invention.

Further scope of applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic perspective view of a printing system configured to print on a roll according to the present invention;

FIG. 2 is a schematic diagram of a control unit of a printer according to FIG. 1;

FIG. 3 are samples of media to be tested according to the present invention;

FIG. 4 is a print media with examples of fiducial markers according to the present invention;

FIG. 5A-5B is a schematic block diagram illustrating the steps of the method according to the present invention; and

FIG. 6 is a diagram of a software product according to the present invention.

### DETAILED DESCRIPTION OF THE PREFERRED EMBODIMENTS

The present invention will now be described with reference to the accompanying drawings, wherein the same reference numerals have been used to identify the same or similar elements throughout the several views.

### Printing System

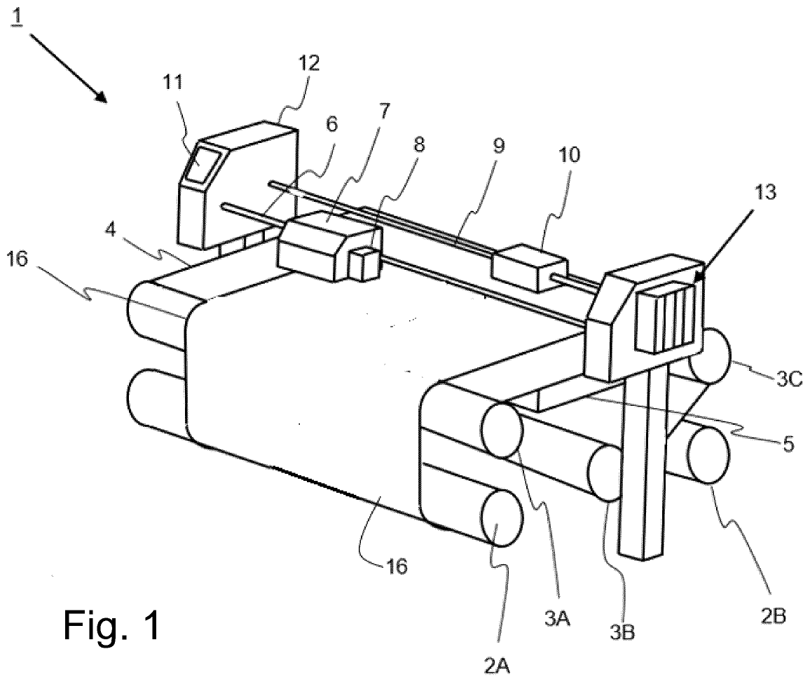

FIG. 1 shows a wide format inkjet printer 1. The wide-format printer 1 comprises an inkjet printing assembly 7 for printing on a print medium 16. The print medium 16 in FIG. 1 is a roll of media. The print medium 16 is supplied from a media input unit (not shown), which may be configured for storing a plurality of such print media 16 and supplying these to the printer 1. The printer 1 comprises transport means for receiving and transporting the print medium 16 along the inkjet printing assembly 7. In FIG. 1, the transport means comprise an endless transport belt 4 supported on a plurality of support rollers 3A, 3B, 3C. At least one of the support rollers 3A, 3B, 3C is provided with driving means for moving the belt 4. Additionally, one or more one of the support rollers 3A, 3B, 3C may be configured to be moved and/or tilted to adjust and control the lateral position of the belt 4. The printer 1 is provided with at least one image scanner 8 near the inkjet printing assembly 7, such as a CCD camera or area camera, in order to scan the printed fiducial markers which are used to determine the relative position of belt 4 and/or the print medium 16. Data from said at least image scanner 8 may be applied to control the position of the belt 4 and/or the print medium 15.

The print medium 15 is transported stepwise and/or in continuous movement.

The inkjet printing assembly 7 is configured to translate along a first guide beam 6 in a scanning direction. The scanning direction is perpendicular to the direction in which the print medium is transported by the belt 4. The inkjet printing assembly 7 holds a plurality of print heads (not shown), which are configured to jet a plurality of different marking materials (different colors of ink CMYKW, primers, coatings, etc.) on the print medium 16. Each marking material for use in the printing assembly 7 is stored in one of a plurality of containers arranged in fluid connection with the respective print heads for supplying marking material to said print heads to print an image on the print medium 16.

The ejection of the marking material from the print heads is performed in accordance with data provided in the respective print job. The timing by which the droplets of marking material are released from the print heads determines their position on the print medium 16. The timing may be adjusted based on the position of the inkjet printing assembly 7 along the first guide beam 6.

The marking materials may require treatment to properly fixate them on the print medium. Thereto, a fixation unit 10 is provided downstream of the inkjet printing assembly 7. The fixation unit 10 may emit heat and/or radiation to facilitate the marking material fixation process. In the example of FIG. 1, the fixation unit 10 is a radiation emitter, which emits light of certain frequencies, which interacts with the marking materials, for example UV light in case of UV-curable inks. The fixation unit 10 in FIG. 1 is translatable along a second guide beam 9. Other fixation units 10, such as page-wide curing or drying stations may also be applied. Further, the inkjet printing assembly 7 may be provided with a further fixation unit on the same carriage which holds the print heads. This further fixation unit can be used to (partially) cure and/or harden the marking materials, independent of or interaction with the fixation unit 10.

After printing, and optionally fixation, the print medium 16 is transported to a receiving unit (not shown). The receiving unit may comprise a take-up roller for winding up the print medium 16 or a receiving tray for supporting sheets of print medium 16. Optionally, the receiving unit may comprise processing means for processing the medium 16 after printing, e.g. a post-treatment device such as a coater, a folder, a cutter, or a puncher.

The wide-format printer 1 furthermore comprises a user interface 11 for receiving print jobs and optionally for manipulating print jobs. The local user interface unit 11 is integrated to the print engine and may comprise a display unit and a control panel. Alternatively, the control panel may be integrated in the display unit, for example in the form of a touch-screen control panel. The local user interface unit 11 is connected to a control unit 12 connected to the printer 1. The control unit 12, for example a computer, comprises a processor adapted to issue commands to the printer 1, for example for controlling the print process. The printer 1 may optionally be connected to a network. The connection to the network can be via cable or wireless. The printer 1 may receive printing jobs via the network. Further, optionally, the control unit 12 of the printer 1 may be provided with an input port, such as a USB port, so printing jobs may be sent to the printer 1 via this input port.

### Control

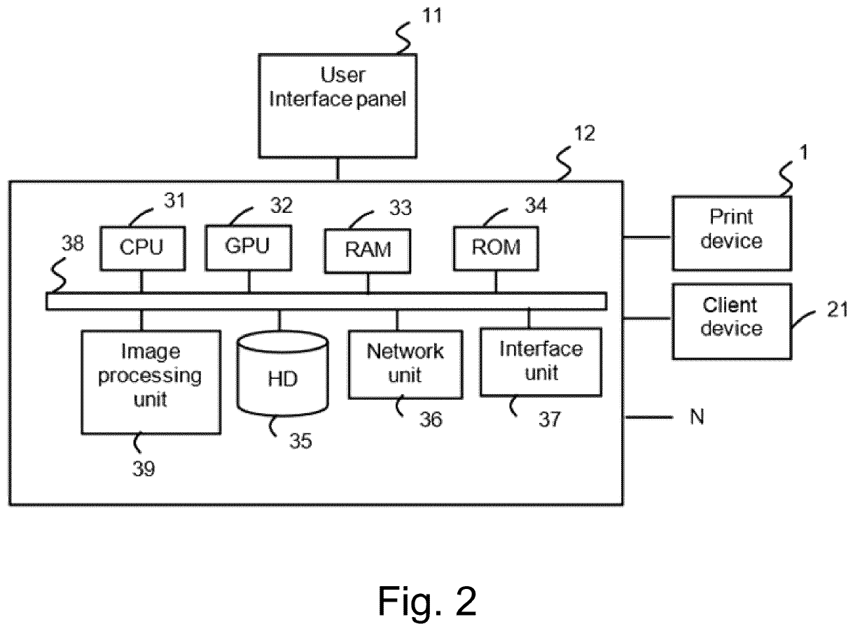

An embodiment of the control unit 12 is in more detail presented in FIG. 2. As shown in FIG. 2, the control unit 12 comprises a Central Processing Unit (CPU) 31, a Graphical Processor Unit (GPU) 32, a Random Access Memory (RAM) 33, a Read Only Memory (ROM) 34, a network unit 36, an interface unit 37, a hard disk (HD) 35 and an image processing unit 39 such as a Raster Image Processor (RIP). The aforementioned units 31-37 are interconnected through a bus system 38. However, the control unit 12 may also be a distributed control unit.

The CPU 31 controls the printing system 1 in accordance with control programs stored in the ROM 34 or on the HD 35 and the local user interface panel 11. The CPU 31 also controls the image processing unit 39 and the GPU 32. The ROM 34 stores programs and data such as boot program, set-up program, various set-up data or the like, which are to be read out and executed by the CPU 31. The hard disk 35 is an example of a non-volatile storage unit for storing and saving programs and data which make the CPU 31 execute a print process to be described later. The hard disk 35 also comprises an area for saving the data of externally submitted print jobs. The programs and data on the HD 35 are read out onto the RAM 33 by the CPU 31 as needed. The RAM 33 has an area for temporarily storing the programs and data read out from the ROM 34 and HD 35 by the CPU 31, and a work area which is used by the CPU 31 to execute various processes. The interface unit 37 connects the control unit 12 to the client device 21 and to the printing system 1. The network unit 36 connects the control unit 12 to the network N and is designed to provide communication with workstations and with other devices reachable via the network N. The image processing unit 39 may be implemented as a software component running on an operation system of the control unit 12 or as a firmware program, for example embodied in a field-programmable gate array (FPGA) or an application-specific integrated circuit (ASIC). The image processing unit 39 has functions for reading, interpreting and rasterizing the print job data. Said print job data contains image data to be printed (i.e. fonts, graphics, rasterized images that describe the content of the document to be printed, described in a Page Description Language or the like), image processing attributes and print settings. The print controller may provide pre-programmed digital images of fiducial markers according to CMYKW colors in different shapes. As soon as a selection of a fiducial marker is done according to the present method, the corresponding digital image may be retrieved from storage or memory of the print controller.

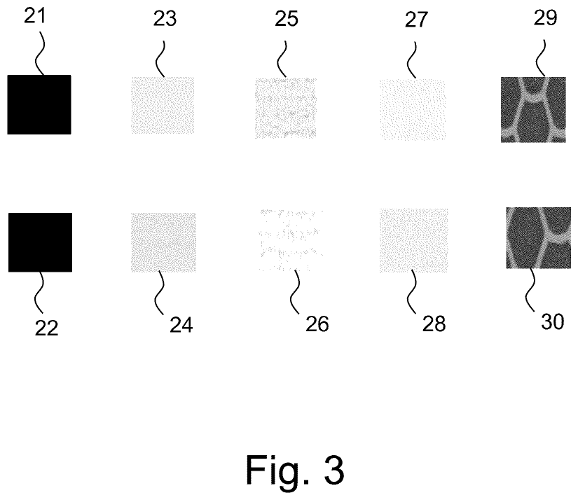

FIG. 3 are samples of print media to be tested according to the present invention. The samples are used to determine the contrast of the print media. Samples may be for example taken from SAV print media. SAV stands for Self-Adhesive Vinyl with full color digital print which is suitable for a wide range of signage applications. Self-Adhesive Vinyl is a printed vinyl which has a sticky back coating so that it can stick to flat non-porous surfaces. Self-Adhesive Vinyls can be glossy or matt with permanent adhesive, glossy or matt with removable adhesive or gloss white highly conformable cast. The special surface coating optimizes ink adhesion and color reproduction for long-lasting brilliant graphics. Samples may be taken from MPI2000 print media which are used for digital printing of durable graphics. MPI2000 is a versatile film which can be applied over all kinds of flat surfaces and even simple curves. Additional opacity can be opted fro by means of a high opacity face film. Samples may be taken from IJM684 print media which are suitable for indoor and outdoor textured floor graphics. IJM684 is a slip resistant, self-adhesive textured matt PVC coated fabric. IJM684 can be adhered to carpets, tiles, concrete, wooden and PVC floors, untreated stone and almost every surface indoor and outdoor. Samples may be taken from IJM613 print media which is a white, highly opaque, blue backed outdoor paper with a barrier coating, which has been specially developed for printing with solvent and UV curable inks. Samples may be taken from print media which contain a honey grate pattern.

A sample 21 is derived from a print media called Red SAV—Blue. A sample 22 is derived from a print media called Red SAV—Amber. A sample 23 is derived from a print media called MPI2000—Blue. A sample 24 is derived from a print media called MPI2000—Amber. A sample 25 is derived from a print media called IJM684, textured SAV—Blue. A sample 26 is derived from a print media called IJM684, textured SAV—Amber. A sample 27 is derived from a print media called IJM613—Blue. A sample 28 is derived from a print media called IJM613—Amber. A sample 29 is derived from a print media with a honeygrate pattern—Blue. A sample 30 is derived from a print media with a honeygrate pattern—Amber. The suffix Blue and Amber indicate the color of the LED which is used by the image scanner 8 for illumination of the print media when taking the scans of the samples of print media. For each print medium a mean, median and standard deviation of the scanner response is calculated by the print controller 31. From all samples together a median of the means of the samples, a median of the medians of the samples and a median of the standard deviations of the samples is calculated by the print controller 31. The following results were obtained, wherein the unit of measurement mentioned in table 1 here-below is the 8-bits number of the scanner responses:

TABLE 1

| | |
|---|---|
| median | std |

| LED | Blue | amber | blue | amber |
|---|---|---|---|---|
| ‘Honeygrate pattern’ | 81 | 79 | 33.9 | 35.7 |
| ‘IJM613’ | 244 | 243 | 2.2 | 4.0 |
| ‘IJM684, textured SAV’ | 238 | 244 | 9.2 | 9.1 |
| ‘MPI2000’ | 236 | 233 | 1.5 | 3.3 |
| red SAV’ | 5 | 22 | 1.2 | 3.0 |

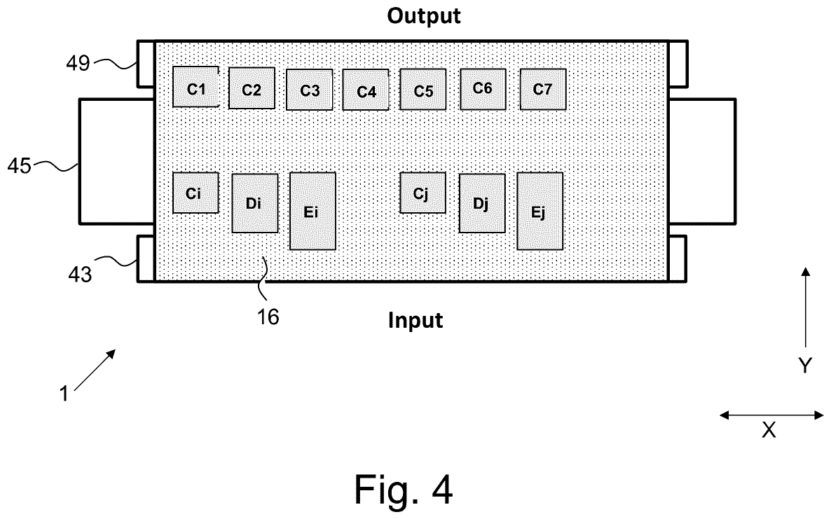

FIG. 4 is a print media with schematic examples of patches according to the present invention. A first category of patches is printed with different colors C1-C7 after a contrast determination on samples of print media 16 by the scanner and the print controller as shown in FIG. 3. The different colors have been selected according to the method of the present invention to be the most promising colors for fiducial markers with respect to visibility on the print medium 16.

The first category of patches is scanned by the scanner when moving the scanner in the X direction and the scanned images are sent to the print controller for analysis on visibility. If according to the analysis of the scanned images one of the patches C1-C7 is sufficient with respect to visibility, a fiducial marker with the one selected color is used to be printed on the prints to be made by the printer on the print medium 16. The fiducial marker may be stored with its color and shape in the media catalogue on the print controller. In another embodiment just the selected color with the standard shape is stored in the media catalogue together with the type of print medium 16.

If none of the patches C1-C7 is sufficient enough, one or more of the most promising colors Ci, Cj are selected for further testing. A second category of patches is printed with the colors Ci-Cj with different shapes Ci, Di, Ei, Cj, Dj, Ej.

The second category of patches is scanned by the scanner when moving the scanner in the X direction and the scanned images are sent to the print controller for analysis on visibility. If according to the analysis of the scanned images one of the patches Ci, Di, Ei, Cj, Dj, Ej is sufficient, the color and the shape of the one patch are selected for the fiducial markers to be printed on the prints to be made by the printer on the print medium 16. The fiducial marker may be stored with its color and shape in the media catalogue on the print controller. In another embodiment just the selected color with the selected shape is stored in the media catalogue together with the type of print medium 16.

Each of the patches C1-C7 in FIG. 4 contain one color. However, patches with more than one color may be envisioned. By combining colors into one patch, less patches need to be printed which leads to calibration time gain and less waste of print medium 16.

During the printing of the patches for the media calibration one or more paper steps in the Y direction are performed. According to an embodiment, during the paper steps, i.e.

when the print medium 16 is moving in the Y direction from the input station to the output station, the print controller is configured to analyse the images of the first category and selecting the promising colors Ci, Cj for the second category of patches. After the selection of the wanted patches of the second category, the print controller sends instructions to the print head station to print the images for the second category of patches according to the colors Ci and Cj and the different shapes of small (Ci, Cj), medium (Di, Dj) and large size (Ei, Ej).

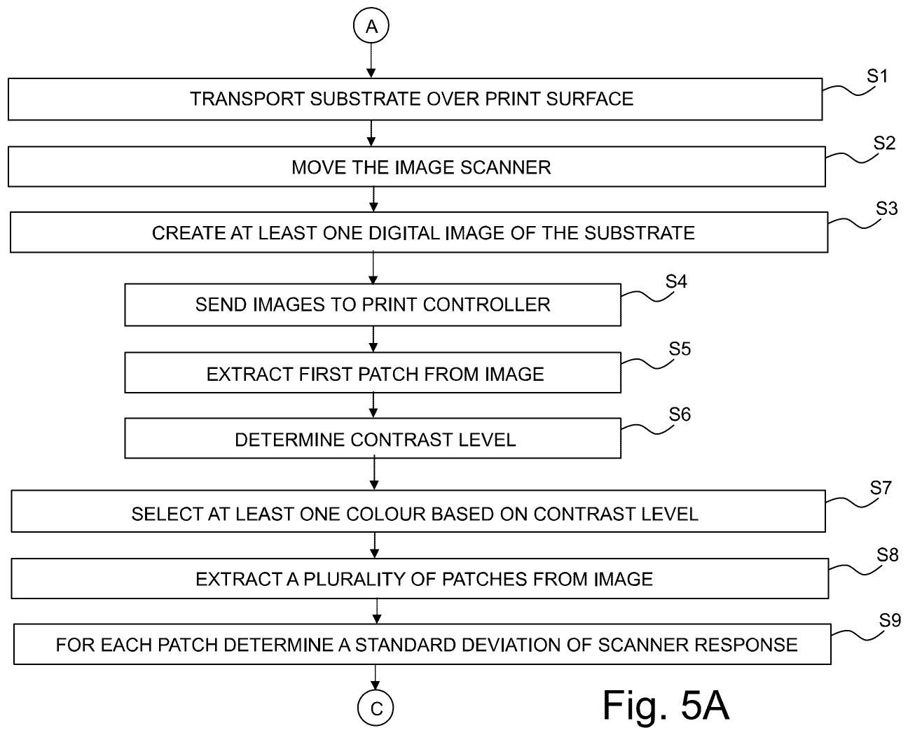

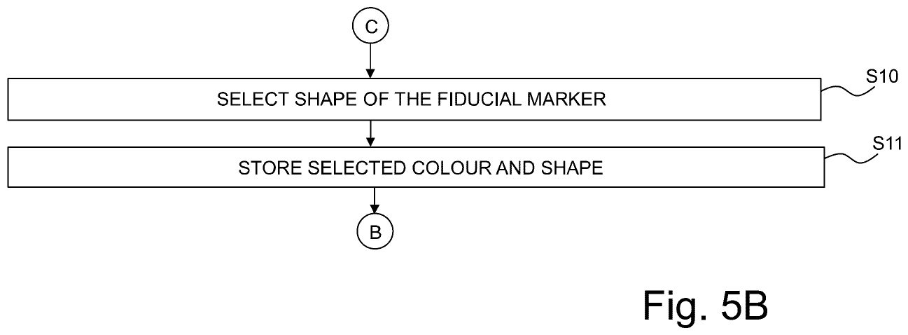

FIG. 5A-5B discloses an example of a first method according to the invention. The first method starts in a starting point A which leads to a first step S1.

In the first step S1 the substrate is transported over the print surface underneath the gantry.

In a second step S2 the image scanner is moving along the gantry in at least one swath.

In a third step S3 the image scanner creates at least one digital image of the substrate when the image scanner is moving along the gantry in the sub-scanning direction.

In a fourth step S4 the image scanner sends the at least one created digital image to the print controller.

In a fifth step S5 the print controller extracts a first patch from the at least one created digital image.

In a sixth step S6 the print controller determines at least one contrast level of the first patch by means of the at least one created digital image.

In a seventh step S7, based on the at least one determined contrast level, the print controller selects at least one color of marking material for printing a fiducial marker on the substrate.

In an eighth step S8 the print controller extracts from the at least one created digital image a plurality of other patches, wherein each patch of the plurality of patches comprises a different part of the substrate.

In a ninth step S9 the print controller determines for each patch of the plurality of patches a standard deviation of the scanner response within the patch.

The method proceeds to an intermediate point C which connects FIG. 5A with FIG. 5B.

The intermediate point C in FIG. 5B leads to a tenth step S10.

In the tenth step S10 the print controller, based on the determined standard deviations, selects at least one shape of the fiducial marker to be printed on the substrate.

In an eleventh step S11 the print controller stores the at least one selected ink color and the at least one selected shape in a print setting for the substrate in a media catalogue in storage of the print controller.

The method ends in an end point B.

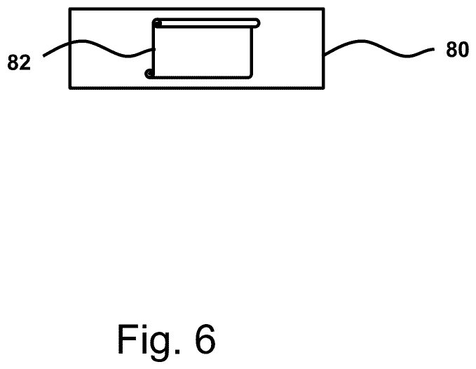

FIG. 6 schematically shows a non-transitory software medium 80 according to the invention. The software medium 80 comprises executable code 82 configured to, when executed, perform the method according to the invention, e.g. as described with respect to either the printing system 1 shown in FIG. 1 or the method of controlling the printing system 1 according to the present invention and/or according to any of the variants and modifications of the printing system 1 and/or of the method described herein.

The non-transitory software medium 80 may, specifically, be formed as a CD or a CD-ROM, a DVD or a DVD-ROM, a BluRay disc or a BluRay-ROM disc, a magnetic hard drive, a solid state disk (SSD) hard drive, a USB memory device and so on.

Although specific embodiments of the invention are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

The present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for determining fiducial markers to be printed on a substrate by means of a printer which is configured to execute a print process and to transport the substrate relatively to a gantry comprising a print head and an image scanner in a main scanning direction over a print surface underneath the gantry, the print head and the image scanner moveable along the gantry in a sub-scanning direction perpendicular to the main scanning direction, the printhead configured to eject marking material on the substrate and the image scanner configured to create scanned images of the printed substrate, and the printer comprising a print controller for control of the print process and comprising a storage with print settings, the method comprising the steps of
a) transporting the substrate over the print surface underneath the gantry,
b) the image scanner moving along the gantry in at least one swath,
c) the image scanner creating at least one digital image of the substrate when the image scanner is moving along the gantry in the sub-scanning direction,
d) the image scanner sending the at least one created digital image to the print controller as a scanner response,
e) the print controller extracting a first patch from the at least one created digital image,
f) determining at least one contrast level of the first patch by means of the at least one created digital image,
g) based on the at least one determined contrast level, selecting at least one color of marking material for printing a fiducial marker on the substrate,
h) extracting from the at least one created digital image a plurality of other patches, wherein each patch of the plurality of patches comprises a different part of the substrate,
i) determining for each patch of the plurality of patches a standard deviation of the scanner response within the patch,
j) based on the determined standard deviations, selecting at least one shape of the fiducial marker to be printed on the substrate, and
k) storing the at least one selected color of the marking material and the at least one selected shape in a print setting for the substrate in a media catalogue in storage of the print controller.

2. The method according to claim 1, wherein the step g) of selecting the at least one color of marking material comprises the sub-steps of
g1) retrieving from the storage a plurality of contrast thresholds for measured contrast levels,
g2) determining a mean contrast level from the at least one contrast level determined in step f),
g3) determining if the mean contrast level in step g2) is low or high compared to a first contrast threshold of the plurality of contrast thresholds,
g4) in case of a high mean contrast level, selecting a color of marking material from a CMYK spectrum,
g5) in case of low mean contrast level
g5.1) in case of a mean contrast level higher than a second contrast threshold of the plurality of contrast thresholds which is lower than the first contrast threshold, selecting both white and a color of the marking material from the CMYK spectrum, and
g5.2) in case of a mean contrast level which is lower than the second contrast threshold, selecting a color white for the marking material.

3. The method according to claim 1, wherein the step j) of selecting the at least one shape comprises the sub-steps of
j1) retrieving from the storage a plurality of standard deviation thresholds for standard deviation levels,
j2) determining a mean or median standard deviation from the plurality of standard deviations determined in step i),
j3) determining if the determined mean of median standard deviation in step j2) is respectively low, high or very high compared to the plurality of thresholds for standard deviations, and
j4) based on the determined mean or median standard deviation, select at least one size for the at least one shape.

4. The method according to claim 1, wherein the first patch comprises an edge of the substrate, and the method comprises the step of determining the at least one contrast level between the substrate and the print surface by means of the first patch.

5. The method according to claim 1, wherein the method comprises the step of receiving a print job to be printed on the substrate and printing the print job together with fiducial markers on the substrate, the fiducial markers having the at least one selected color and the at least one selected shape on the substrate.

6. A printer configured to execute a print process and to transport a substrate relatively to a gantry comprising a print head and an image scanner in a main scanning direction over a print surface underneath the gantry, the print head and the image scanner moveable along the gantry in a sub-scanning direction perpendicular to the main scanning direction, the printhead configured to eject marking material on the substrate and the image scanner configured to create scanned images of the printed substrate, and the printer comprising a print controller for control of the print process and comprising a storage with print settings, wherein the print controller is configured to execute the steps of the method according to claim 1.

7. The printer according to claim 6, wherein the printer is a roll-fed printer or a sheet-fed flatbed printer.

8. A non-transitory medium comprising program code, which program code, when loaded into a print controller of a digital printer, causes the print controller to execute the steps of the method according to claim 1.
